(19) United States
(12) Patent Application Publication
(10) Pub. No.: US 2007/0168390 A1
(43) Pub. Date: Jul. 19, 2007

(54) Amusement park management

(75) Inventor: Aris Mardirossian, Germantown, MD (US)

Correspondence Address: NIXON & VANDERHYE, PC, 901 NORTH GLEBE ROAD, 11TH FLOOR, ARLINGTON, VA, 22203, US

(73) Assignee: Technology Patents, LLC, Derwood, MD (US)

(21) Appl. No.: 11/332,463

(22) Filed: Jan. 17, 2006

(51) Int. Cl. G06F 17/00

(52) U.S. Cl. 707/104.1

(57) ABSTRACT

A system and/or method for, e.g., amusement park, facility management is provided. In certain example embodiments, a patron is issued a pass (e.g., handheld electronic device) when that patron enters an amusement park. The pass includes, for example, a list of attractions for which the user is authorized. In some example embodiments, patrons who are authorized for a given attraction receive priority over non-authorized patrons and therefore are able to participate in the attraction more quickly than non-authorized patrons. Authorizations preferably change in certain example embodiments depending, for example, on the length of lines in various parts of the amusement park to facilitate an efficient flow of patrons through the park.

### FIELD OF THE INVENTION

This invention relates to a system and/or method for amusement park management, including management of customer lines at different rides and/or events in the park. In certain example embodiments, a system and/or method is provided wherein patrons (or customers) at an amusement park are authorized to participate in certain attractions based on, for example, the number of patrons in line at particular attractions. In certain example embodiments, patrons who are authorized for particular attractions receive priority over those who are not authorized.

### BACKGROUND AND SUMMARY OF EXAMPLE EMBODIMENTS OF THE INVENTION

Every year, thousands of people visit amusement parks, including theme parks, around the country. Patrons visit amusement parks, for example, while on vacation, for a break from the monotony of daily working life, as a treat for children, etc. Amusement parks are intended to provide exactly that—amusement.

However, the amusement of patrons quickly may turn to dismay as a result of various inconveniences inherent to amusement parks. Patrons of amusement parks may become frustrated with large, sprawling parks, for example, because they cannot successfully navigate the entire park to find the rides and or attractions they seek. Smaller parks with less attractions are likely to become too full and/or bogged down as more and more patrons come throughout the day.

It is common for patrons to cluster around only a few rides and/or attractions, such as, for example, the most popular rides, the newest rides, rides for small children, rides near an entrance to the park, etc. With rides and features often categorized by theme (e.g. by historic era, region of the world, type of sea-faring animal, etc.), certain themes are bound to be more popular than others and patrons may naturally congregate at these points and utilize the services in these areas more frequently. As another example, patrons may congregate at rides or events near the entrance to a park because these are the first rides or events seen by the patrons upon entering the park.

Backups at particular attractions may affect the entire area and/or theme in which the attraction is located by reducing the ideal flow of people through the attractions in one area and to attractions in another area, to a crawl. Thus, a backup at one attraction may cause a backup in a larger segment of the park. Moreover, it is easy to see how an amusement park-wide problem may originate with backups in one area. Consider, for example, a new attraction in a certain area of an amusement park. Many patrons will encounter long lines waiting to participate in the new attraction, resulting in an immediate drop in pleasure levels and thus overall satisfaction with the park. However, the problem is not so confined. While some may be willing to wait through long lines, others may use features proximate to the ride in the hopes that the lines will dissipate. Thus, patrons will pour into stores and cafeterias, for example, while waiting. Patrons may additionally ride less popular rides that they ordinarily would not frequent, for example. The end result may be a congregation of patrons in one specific part of the amusement park. Patrons seeking to ride a particular ride may too heavily tax the ability of the amusement park to provide all services. Thus, it will be appreciated that overcrowding, long waits in line, poor flow of people, etc. represent problems to amusement parts.

The poor flow of people through the park is disadvantageous not only for the patrons, but also for the park itself. Less happy patrons likely will be less willing consumers of ancillary goods and services. For example, patrons who do not have a good time will not want souvenirs to remind themselves of bad times. Having too many patrons concentrated in one area reduces potential throughput, for example, at restaurants, shops, various pay-to-play attractions, etc. Clogs at one area of the park may restrict patrons' abilities to spend, thus impacting the bottom line of the amusement park. Additionally, parks may ineffectively staff certain parts of the parks, resulting in both over- and/or under-manning of attractions, services, and features of the amusement park. In general, then, parks may ineffectively target their resources.

These problems become compounded as new features and services are added, resulting in a level of unpredictability as to the potential number of patrons, the attractions they will seek out, etc. Flows and blockages often cannot be predicted, as they change throughout the day and on a daily basis.

Thus, it will be appreciated that there is a need for a system and/or method for improved amusement park management. In certain example embodiments, a method of influencing the flow of patrons at an amusement park is provided. Such a method may include the steps of authorizing a patron to participate in certain attractions at the amusement park, issuing a pass that includes authorization information, allowing patrons to form at least one line to participate in an attraction, and giving patrons with authorization for a certain attraction priority over patrons without authorization. In certain example non-limiting embodiments, the method may also call for patrons who are not authorized for a particular attraction to wait in a line separate from a faster-moving and/or shorter line for patrons authorized for the attraction.

In other example non-limiting embodiments, the method may detect backups and/or openings in and/or around certain attractions, and may update the authorization information based on the detected backups and/or openings. In certain example embodiments, the updating step only will be performed if the backup and/or opening detected is above a threshold value, which may be based on an absolute numerical value, on a percentage of the total number of patrons in the amusement park, or the like.

In another example embodiment, authorizations may not be issued for a particular attraction if a line for that attraction is above a predetermined threshold (e.g., in terms of the number of people waiting in line, and/or the time required for a patron to reach the attraction after getting into line), while authorizations may optionally be revoked for a particular attraction if a line for that attraction is above a predetermined threshold. Furthermore, in certain example embodiments, authorizations may be issued for a particular attraction if a line for that attraction is at or drops below a predetermined threshold, while authorizations may be restored for a particular attraction if a line for that attraction is at or below a predetermined threshold.

In still another example embodiment, a system for influencing the flow of patrons at an amusement park is provided. This system may include an issuing authority that issues a pass (e.g., card) for at least one patron, with the pass including authorization information. The system may include a database that tracks the authorization information; at least one detector that monitors at least one line for at least one attraction for backups and/or openings; a balancer that determines whether and which authorizations should be issued, revoked, and/or restored; and, a communicator that conveys the balanced authorization data to the issuing authority and/or patrons. In certain example embodiments, changes by the balancer may be reflected in the authorization database.

In certain example non-limiting embodiments, the pass (or card) carried by a patron may be remotely updatable. Furthermore, in some example embodiments, the pass may be a smart-card, or a mobile device, such as, for example, a PDA, a cell phone, etc. The card may be updated with new authorization information as lines at different attractions change throughout the day. For example, the card may be updated with authorizations for different rides as lines for such rides become shorter, or the card may be updated with non-authorizations for certain rides as lines for such rides become too long.

In certain example embodiments, there is provided a method of influencing the flow of patrons at an amusement park (or a corresponding system), the method comprising: authorizing a patron to participate in certain attractions, but not other attractions, at the amusement park; issuing a pass to the patron that includes authorization information for the certain attractions that have been authorized, but does not include authorization information for the other attractions that have not been authorized; monitoring lines at different attractions in the amusement park; and based on the monitoring of the lines, adjusting which attractions are authorized and which are not with respect to new patrons arriving at the amusement park and/or patrons already at the amusement park.

In other example embodiments, there is provided a method of influencing the flow of patrons at a facility (e.g., amusement park, zoo, casino, or the like) including a plurality of attractions, the method comprising: authorizing a patron to participate in certain attractions, but not other attractions, at the facility; monitoring lines at different attractions at the facility; and based on the monitoring of the lines, adjusting which attractions are authorized and which are not with respect to new patrons arriving at the facility and/or patrons already at the facility.

### BRIEF DESCRIPTION OF THE DRAWINGS

These and other features and advantages will be better and more completely understood by reference to the following detailed description of exemplary illustrative embodiments in conjunction with the drawings, of which:

FIG. 1 is an illustrative flowchart showing an example process for managing the flow of patrons at an amusement park;

FIG. 2 is an illustrative flowchart showing an example process for changing patron authorizations;

FIG. 3 is a partial schematic view of an example system for managing the flow of patrons at an amusement park; and,

FIG. 4 is a non-limiting illustrative partial layout of a pass with a digital display.

### DETAILED DESCRIPTION OF EXAMPLE EMBODIMENTS OF THE INVENTION OF THE INVENTION

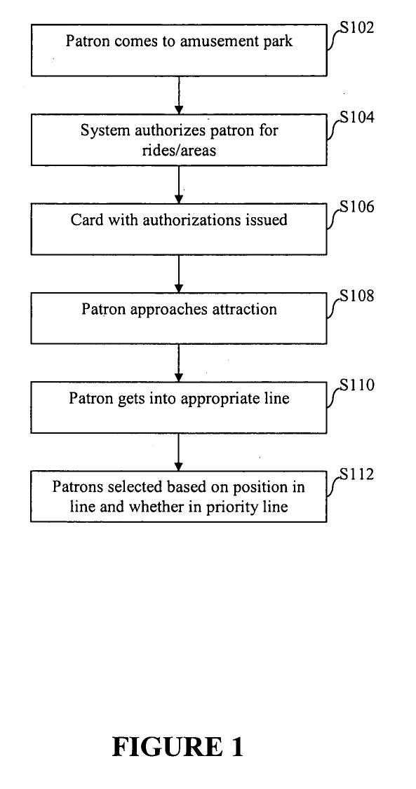

Referring now to the drawings, FIG. 1 is an illustrative flowchart showing an example process for managing the flow of patrons at an amusement park. The process begins when a patron comes to, or arrives at, an amusement park in step S102. Typically, in a step not shown, the patron pays for admission to the amusement park. At this point, in step S104, the system authorizes patrons for certain rides and/or areas within the amusement park. The authorization process (e.g., which rides are authorized for a given patron, and/or which rides are not authorized for the patron) preferably is based at least on at least one of: the current status of lines at different rides in the park, the number of people currently in the park, and the entrance closest to where the patron arrive. For example, all attractions may be open to all patrons arriving early in the morning because there may not be any long lines or immediate backups at rides at this time. Of course, if there are long lines waiting when the park opens, it may be necessary and/or advantageous to begin with an initial even disbursement of patrons throughout the park. Later in the day, for example, as congestion grows, the system may limit the authorizations of new patrons to areas that are not as crowded.

Crowdedness, line backups, and the like can be measured in numerous ways. They can be computed, for example, by simply counting the number of people in a given line and/or within a given area, etc. Rather than setting a threshold number for crowdedness, the threshold may be based on a percentage—e.g. the percentage of patrons in a given area compared to the number in the entire amusement park, etc. The system might use a combination of number and percentage—e.g. imposing a rule that does not authorize people for a particular ride if there are more than 50 people in line for that ride, or if more than 5 percent of the total number of patrons in the park are in line for that particular ride, etc. The number of people in line for a particular attraction may be determined using GPS positioning based on authorization cards being carried by the patrons, by visual methods, or in any other suitable manner.

Models may be employed to arrange the ideal flow of patrons through the system. Data on the riding habits of patrons can be maintained and models extracted therefrom. For example, some people will wait in line regardless of whether they are authorized for a particular ride. Thus, it may be advantageous to revoke authorizations for multiple rides within the same area to pull patrons away from a particular attraction, for example. The extent to which this is necessary may be based on a flow model, graph, etc.

The threshold need not be mathematically set and/or derived. For example, amusement park employees might control the system based on their subjective views of how the park is operating. For example, if amusement park employees determine that too many people are in one particular area while too few are in another, they may cease issuing authorizations for all rides within all areas except for the comparatively empty area.

The authorization process in some example embodiments may be based on other criteria in place of, or in addition to, crowdedness. For example, patrons paying a premium or otherwise enjoying a special status may be authorized for more rides and/or attractions. Authorization may also be withheld because of height and/or weight restrictions. For example, it is unsafe for people below a certain height to ride certain rollercoasters (e.g., small children may not be authorized for certain rides for which they are not tall enough). Additionally, patrons may be authorized based on whether they arrive before a special event and/or at a certain time. For example, no individuals may be authorized to access a particular street to facilitate clearing an area before a parade.

After authorizations are granted, a pass with such information embedded therein is issued in step S106. This pass may be a card with a chip or circuit thereon, including a wireless transmitter and/or receiver. Passes preferably will be made of a resilient material as are credit cards. In certain example embodiments, passes may be kept by patrons, for example, as souvenirs, for future visits to the amusement park, etc. In other example embodiments, the passes may be disposable. However, for hi-technology passes, it will be appreciated that passes may be reusable and collected from patrons, for example, as they leave the amusement park.

In certain example embodiments, the pass may be issued in the form of a smart-card, which ideally is approximately credit-card sized and includes a microchip to keep track of authorizations. The smart-card preferably may also include a transmitter and/or receiver so that it can be updated remotely as new authorizations are granted and/or old authorizations are revoked throughout the day, for example. In certain example embodiments, the smart-card may vibrate and/or blink to indicate that a certain attraction has become available, thereby alerting the patron having the card to a change in authorization status. Smart-cards may have GPS features enabled, for example, to help locate missing cards. GPS-enabled smart-cards also may help users navigate an amusement park. Similarly, GPS-enabled smart cards held by missing children could facilitate with their location. Moreover, GPS in the cards may be used by the amusement park to help the park keep track of where patrons are located (e.g., if GPS indicates that too many patrons are in line for a particular attraction, authorizations may be reduced or stopped for that attraction).

The smart-cards may have additional information stored, recorded, encoded, etc. thereon. For example, the smart-cards may be tied to credit card information to allow patrons to make quick purchases, and/or to have their accounts debited as a result of purchases in the park. They also may include, for example, contact information to locate a missing person, missing smart-card, replace a found smart-card, etc.

While certain example embodiments will utilize a smart-card, Step S106 does not require a smart-card in all instances. For example, similar features in other example embodiments may be provided by tying authorizations to a PDAs, cell phones, mobile devices, etc. In certain low-technology example embodiments, authorizations may be tracked on a single piece of paper, ticket colors, or the like, for example.

After authorizations are issued, the patron is free to move about the amusement park. In step S108, the patron approaches an attraction such as a ride (e.g., roller-coaster) or event (e.g., show). It will be appreciated that the attraction may be, for example, a ride, specific area and/or theme, show, etc. In certain example embodiments, an attraction may have two patron lines—for example, one for authorized patrons, and one for non-authorized patrons. Users get into the appropriate line in step S110. A greater percentage of patrons in the authorized line may be selected for a ride, for example, compared to the non-authorized line, thereby allowing the authorized line to move faster and be more attractive to the patrons than the non-authorized line.

Patrons may know whether they are authorized for a certain attraction in any number of ways. In some example embodiments, the pass may include a digital display (e.g. LED, LCD, etc.) displaying, for example, authorization information. For example, a smart-card may be read by a machine (for example, swiping it through the machine, holding it near a receiver, etc.) to quickly and clearly display authorization data. A reading machine in some example embodiments may be useable by patrons (for example, at attractions, rides, special kiosks through the park, etc.) at the entrance to a line or the like, while in other example embodiments the reading machine may be operated only by amusement park employees. In still other embodiments, patrons may be told by amusement park employees whether they are authorized for a given attraction (or attractions), either initially, as time progresses, etc.

Once in line, in step S112, patrons are selected for the attraction based, for example, on their position in line and whether they are in a priority line. Preferably, patrons in the authorized line will receive preference over patrons in the non-authorized line (e.g., 9 out of every ten people selected for the ride will be taken from the authorized line, with the remainder being selected from the non-authorized line). It will be appreciated that the exact proportion of authorized-to-non-authorized patrons selected for a line may vary. In some example embodiments, it may be preferable to take approximately 90 percent of patrons from the authorized line and 10 percent of patrons from the non-authorized line. This causes authorized lines to move faster, and discourages patrons from attractions for which they are not authorized.

In a step not shown, in certain example embodiments, after a patron participates in an attraction, authorization for that attraction may be revoked, for example, to give others a chance to participate in that attraction. The park may know that the patron has used the ride based on a card swiping device, or based on GPS techniques in certain example instances. It will be appreciated that, in certain example embodiments, a patron may have authorization revoked after, for example, riding a ride more than a predetermined number of times (e.g., more than 2 times, or more than 3 times), misbehavior at an attraction, etc.

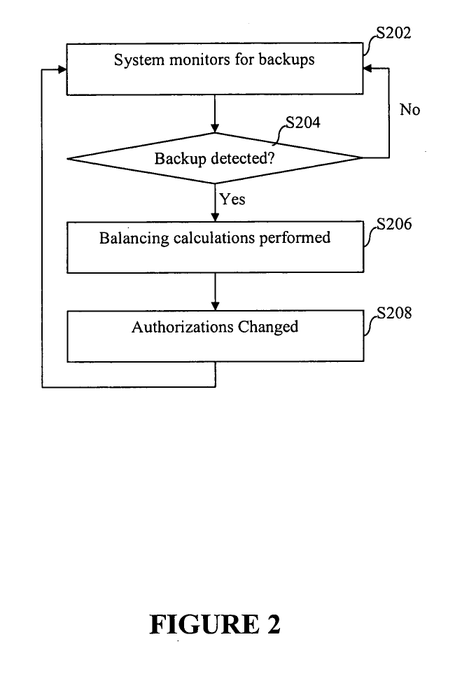

Authorizations on the card or hand-held device may be updated throughout the daily operation of an amusement park to account for changing conditions. For example, patrons may decide to upgrade their status and pay more money to become authorized for more attractions. In an example embodiment, the system may be updated based on backups and/or openings (reductions) detected in lines at different attractions. FIG. 2 is an illustrative flowchart showing an example process for changing patron authorizations. Although FIG. 2 describes a process for changing patron authorizations based on detected backups, it will be appreciated that the process applies to an analogous process for changing patron authorizations based on detected openings (line reductions).

In step S202, the system monitors for backups in lines at certain attractions. As described above, backups may be detected based on, for example, absolute numbers in a particular line (e.g., above a predetermined threshold), a percentage of patrons in a particular line (e.g., again, above a predetermined threshold), etc. If a backup is not detected, step S204 returns the system to step S202, where the system continues monitoring for backups. If a backup is detected, step S204 preferably moves the system to step S206 where balancing calculations are performed. Balancing calculations may include, for example, flow analyses to facilitate the movement of people around the amusement park, etc.

Step S208 changes authorizations in response to the balancing calculations performed in step S206. These changes may include, for example, changing current authorizations, limiting future authorizations, restoring past authorizations, etc. For example, when a line for an attraction is too long, the system may stop authorizing new users for that attraction and/or start sending new users to other areas of the park where lines are smaller or non-existent. If the backup does not subside, the system may, for example, start revoking authorizations in certain example instances. If backups in a particular line eventually subside, it may, for example, restore authorizations and/or begin authorizing new patrons, etc.

As indicated above, a change in authorizations may be indicated on the pass (e.g., card carried by each patron, or most patrons, in the park). In certain example embodiments, a pass may, for example, include a digital readout that may change as authorizations are changed. In other example embodiments, patrons may check a kiosk to display their current authorizations. In still other example embodiments, amusement park employees may inform patrons of their authorizations.

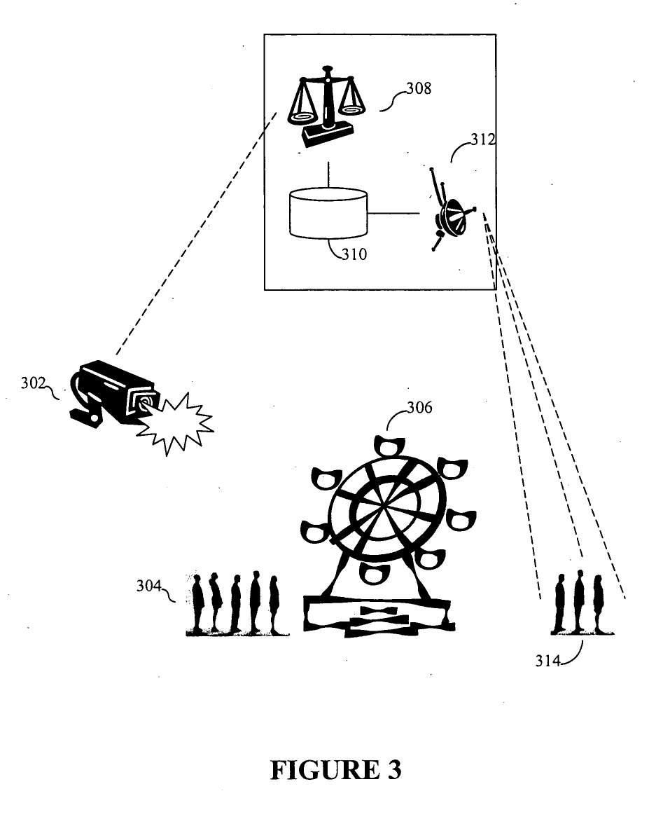

FIG. 3 is a partial schematic view of an example system for managing the flow of patrons at an amusement park. In certain example embodiments, an issuing authority (not shown) issues passes to patrons. Camera(s) 302 monitors line(s) 304 at attractions(s), e.g., where a line is comprised of a group of patrons waiting for attraction 306. Camera 302 relays information about the length of line 304, the number of patrons in the line, and/or the like. In certain example embodiments, this information might include the number of people in line, whether the line has backed up beyond a certain point, how quickly people are moving through the line, etc. This information may be obtained by a park employee viewing the image data obtained from the camera, or may be obtained automatically by software analyzing the image data in certain other instances.

The information is relayed from camera 302 to balancer 308. In some example embodiments, balancer 308 also will examine the authorization information included in authorization database 310. Based on the information reported by camera 302 and the data from authorization database 310, balancer 308 may adjust the authorization information so that not too many people are authorized for a given attraction(s). For example, balancer 308 may determine that new patrons should not receive authorization for a certain attraction (e.g., if there is a very long line for that attraction), that some authorizations should be revoked because too many people are trying to access a certain attraction, that certain authorizations should be restored, and/or the like. This information may be conveyed by communicator 312 (e.g., transmitter). In some example embodiments, communicator 312 will communicate between balancer 308 and patrons 314 by updating electronic passes through, for example, wireless communications, Bluetooth technologies, over an RF frequency, by pages, and/or the like. In other example embodiments, communicator 312 will relay information to amusement park employees (not shown) to prompt them to take proper action, for example, when issuing new passes. In other example embodiments, communicator 312 will relay information to a kiosk(s) that may be accessed by patrons in the park.

Although FIG. 3 shows only one camera in front of one attraction, it will be appreciated that a plurality of cameras may be deployed for a plurality of attractions. It also will be appreciated that technology other than still or video cameras may be used to report on the status of a line. For example, motion sensors, human operation, IR detectors, turnstiles at attractions, etc. may be substituted or used in combination to report on the status of lines, the flow through an area or attraction, etc. It also will be appreciated that one camera or detector may monitor several lines, several areas, etc. by, for example, having a broad area, pivoting and/or rotating to take in additional vantage points, etc.

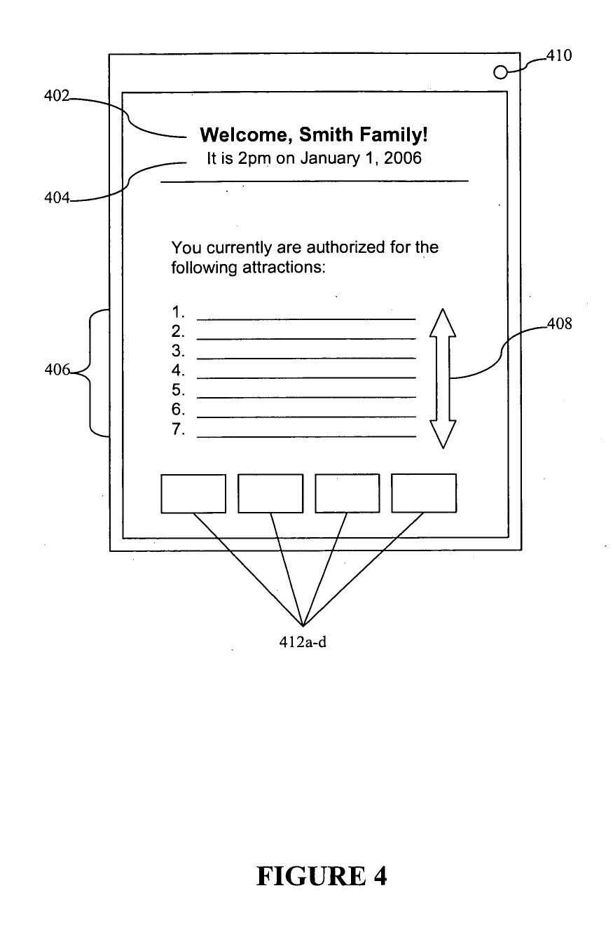

FIG. 4 is an example illustrative partial layout of a pass (e.g., card or other handheld electronic device) with a digital display. It will be appreciated that FIG. 4 is only one example of a pass, and alternative arrangements of the information included therein are possible. It also will be appreciated that other information may be present in addition to, or in place of, that present in FIG. 4. Additionally, it will be appreciated that the features in FIG. 4 may not be present and/or possible in all embodiments of passes.

In the pass (handheld electronic device such as a card or the like) of FIG. 4, text area 402 displays a welcome message, which, in this example embodiment, includes the family name (“Smith”) of the patron(s) using the pass. The display may be performed by an LCD or LED display built into the pass. Text area 404 includes the current date and time. It will be appreciated that text area(s) 402 and 404 may include other information in addition to, or in place of, the information displayed. Authorized attractions list 406 preferably includes a unique description of the attractions for which the patron is authorized. It will be appreciated that although seven blanks are shown in FIG. 4, fewer or more entries may be present depending on, for example, the size of the pass, the number of attractions available to the patron(s), etc. In the case that there are more attractions available than space on the display, scrolling mechanism 408 is displayed to allow the patron using the pass to move through the list of authorized attractions.

In this example embodiment, LED light 410 blinks when a new attraction is added to the list of attractions, or if an attraction is deauthorized or removed from the list. In certain example embodiments, LED light 410 also may indicate, for example, the power status of the device. In this example embodiment, four buttons 412a-d are shown. Preferably, in some example embodiments, buttons may allow a patron to, for example, view a map, see current information about the amusement park, request help, change modes of the pass, etc.

It will be appreciated that although the example embodiments herein have been described in relation to an amusement park, the present invention is not so limited. The systems and methods disclosed herein may be used in other settings, such as, for example, in theme parks, adventure parks, zoos, aquariums, casinos, and the like. The present invention is particularly well suited to any area where there is the potential for long lines at attractions or objects of interest within discrete zones.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of influencing the flow of patrons at an amusement park, the method comprising:
authorizing a patron to participate in certain attractions, but not other attractions, at the amusement park;
issuing a pass to the patron that includes authorization information for the certain attractions that have been authorized, but does not include authorization information for the other attractions that have not been authorized;
monitoring lines at different attractions in the amusement park; and
based on the monitoring of the lines, adjusting which attractions are authorized and which are not with respect to new patrons arriving at the amusement park and/or patrons already at the amusement park.

2. The method of claim 1, further comprising requiring patrons who are not authorized for a particular attraction to wait in a line for that attraction that is separate from a line for patrons authorized for that attraction.

3. The method of claim 1, further comprising detecting reductions in patron lines and/or significant backups in patron lines for at least certain attractions, and updating said authorization information based on the reductions in patron lines and/or backups.

4. The method of claim 1, further comprising determining when the number of patrons in line is above a predetermined threshold, and if so then updating authorization information for at least some patrons.

5. The method of claim 1, further comprising determining when the number of patrons in line is below a predetermined threshold, and if so then updating authorization information for at least some patrons.

6. The method of claim 1, wherein said pass is provided to a patron and is a handheld electronic device which displays to the patron which attractions the patron is authorized for and/or which attractions the patron is not authorized for.

7. The method of claim 6, wherein the handheld electronic device includes a wireless transmitter and/or received so that authorizations for the user displayed on the handheld electronic device can be remotely updated and/or adjusted by an amusement park authority.

8. A method of influencing the flow of patrons at an amusement park, the method comprising:
determining the number of patrons in line for at least certain attractions;
determining whether or not to authorize a patron to participate in or at a given attraction based at least on the number of patrons in line for the given attraction;
providing a handheld electronic device to the patron that includes authorization information for at least certain attractions in the amusement park;
allowing patrons to form at least one line to participate in an attraction; and
giving patrons with authorization for a certain attraction priority over patrons without authorization.

9. The method of claim 8, wherein authorizations are not issued for a particular attraction if a number of persons in line for that attraction is above a predetermined threshold.

10. The method of claim 8, wherein authorizations are revoked for a particular attraction if a number of persons in line for that attraction is above a predetermined threshold for at least a predetermined period of time.

11. The method of claim 8, wherein authorizations are issued for a particular attraction if a number of persons in line for that attraction is at or drops below a predetermined threshold.

12. The method of claim 8, wherein authorizations are restored for a particular attraction if a line for that attraction is at or drops below a threshold.

13. The method of claim 8, wherein the handheld electronic device includes a wireless transmitter and/or received so that authorizations for the user displayed on the handheld electronic device can be remotely updated and/or adjusted by an amusement park authority.

14. The method of claim 8, wherein the handheld electronic device is a PDA.

15. The method of claim 8, wherein the handheld electronic device is a cell phone.

16. A method of influencing the flow of patrons at a facility including a plurality of attractions, the method comprising:
authorizing a patron to participate in certain attractions, but not other attractions, at the facility;
monitoring lines at different attractions at the facility; and
based on the monitoring of the lines, adjusting which attractions are authorized and which are not with respect to new patrons arriving at the facility and/or patrons already at the facility.

17. The method of claim 16, further comprising providing a patron with a handheld electronic device that includes authorization information for the certain attractions that have been authorized, but does not include authorization information for attractions that have not been authorized.

18. A system for influencing the flow of patrons at an amusement park, the system comprising:
means for authorizing a patron to participate in certain attractions, but not other attractions, at the amusement park;
means for providing the patron with a handheld electronic device that includes authorization information for the certain attractions that have been authorized, but does not include authorization information for the other attractions that have not been authorized;
means for monitoring lines at different attractions in the amusement park; and
means for, based on the monitoring of the lines, adjusting which attractions are authorized and which are not with respect to new patrons arriving at the amusement park and/or patrons already at the amusement park.
